(19) United States
(12) Patent Application Publication
(10) Pub. No.: US 2006/0259501 A1
(43) Pub. Date: Nov. 16, 2006

(54) Network-compliant information recording/reproducing device and method of controlling the same

(75) Inventor: Nobuaki Suzuki, Ome-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/434,214

(22) Filed: May 16, 2006

(30) Foreign Application Priority Data
May 13, 2005 (JP) 2005-160349

(51) Int. Cl. G06F 7/00

(52) U.S. Cl. 707/100

(57) ABSTRACT

The invention is configured such that, when content is moved or copied from a sender device to a receiver device, content suitable for a condition can be automatically selected to be collected and stored into one folder by merely carrying out designation in great units. There are provided a specific folder setting unit which sets a specific folder in which content having attribute information suitable for a condition is collected and stored, an attribute analysis unit which, when content to be stored is taken in from the exterior, analyzes the attribute information, and a folder control unit which, when content to be stored has predetermined attribute information suitable for the condition as a result of attribute analysis, stores the content in the specific folder.

### CROSS-REFERENCE TO RELATED APPLICATIONS

This application is based upon and claims the benefit of priority from Japanese Patent Application No. 2005-160349, filed May 31, 2005, the entire contents of which are incorporated herein by reference.

### BACKGROUND

1. Field

One embodiment of the invention relates to a network-compliant information recording/reproducing device and a method of controlling the same, and more specifically, to a technology effective under the circumstances that a plurality of information recording/reproducing devices are connected via a network.

2. Description of the Related Art

In recent years, equipment connectable via a network has diversified into various kinds. Such equipment includes, for example, personal computers, servers, television receivers, a single information recording/reproducing device, and the like. Interfaces for network connection as well have been developed, and files of moving images and the like can be collectively compressed for transmission/reception.

Further, recording media for use in information recording/reproducing devices have been advanced, which makes the capacities thereof larger. As a result, because a large quantity of content can be recorded on the recording media, a technology relating to classification and arrangement of content has been requested.

As a technology for sharing content, there is, for example, a technology in Jpn. Pat. Appln. KOKAI Publication No. 2002-175234. Here, there is disclosed a technology in which content to be shared are shared among a plurality of terminals. The plurality of terminals have a shared folder, and respectively store shared content in the shared folder. Therefore, if each of the respective terminals can have content in common via a communication line from one server, there is no need to download the content. It suffices for the terminals to exchange shared content.

Furthermore, as a technology relating to classification and arrangement of content, there is, for example, a technology in Jpn. Pat. Appln. KOKAI Publication No. 2002-30352560. Here, additional information are added to music data. When music data is fetched in, the music data is stored in a corresponding folder among a plurality of folders on the basis of additional information.

Moreover, Jpn. Pat. Appln. KOKAI Publication No. 2002-092537 discloses a technology in which received messages can be automatically classified into a designated folder on the basis of folder designating information, and can be stored to be managed.

In a conventional network-compliant information recording/reproducing device (including generally a hard disk recording/reproducing device which has a built-in computer, server, and television receiver), the following operation is carried out while monitoring a screen when a file is copied or moved from a sender device to a receiver device. For example, a search for a receiver device is made through a network while monitoring a display screen in a sender device. Next, when a receiver device is selected, a folder of the receiver device is selected. On the other hand, a folder of the sender device is opened, and content in the folder (for example, a title name) is selected. Then, designation of movement or copying is carried out. When copying is designated regardless of content including copy protect information, a caution is indicated, and it is denied to copy the content.

As described above, when content is moved or copied from a sender device to a receiver device in the conventional device, it is necessary to carry out detailed designation. Therefore, there is the problem that the operation is troublesome. For this reason, an extreme operation time is required, for example, in order to store content in a certain genre or type into one folder collectively.

### BRIEF SUMMARY OF THE INVENTION

According to one embodiment of the invention, it is to provide a network-compliant information recording/reproducing device and a method of controlling the same. That is, it is configured such that, when content is moved or copied from a sender device to a receiver device, content having a predetermined attribute (suitable for a condition) can be automatically selected to be collected and stored in one folder by carrying out designation in great units.

In order to attain the above object, in the embodiment of the invention, there is provided an information recording/reproducing device comprising: a connection unit which is connected to a network; an encoder which encodes an input signal from the connection unit in a predetermined format; a recording processor unit which records encoded data on an information recording medium; a reproducing processor unit which reproduces data recorded on the information recording medium; a decoder which decodes reproduced data, and a control unit which overall controls the device, the network-compliant information recording/reproducing device comprising: a specific folder setting unit which sets a specific folder in which content having predetermined attribute information associated therewith is collected and stored; an attribute information setting unit which sets the attribute information with respect to content stored in the specific folder; an attribute analysis unit which analyzes the attribute information when content to be stored is taken in via the connection unit; and a folder control unit which, when the content to be stored has predetermined attribute information suitable for a condition as a result of analysis in the attribute analysis unit, stores the content to be stored in the specific folder.

The embodiment described above enables realization of an image processing device and an image processing method which can carry out, in addition to usual image processings such as scanning or copying, generation of reduced images such as thumbnail images and preview images which are necessary at the time of selecting an image or confirming the content with a small-scale circuit at a high speed, in an image scanner by which information on paper is read and made to be an electronic file, or a digital multifunctional device (MFP) for filing an image at the same time of copying the image onto paper. The above-described means makes it possible to, when reduced images are displayed in reading process, carry out processing of generating reduced images at a high processing speed without lowering a processing speed of the reading processing.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an explanatory block diagram showing the configuration of one embodiment of the invention;

FIG. 2A is an explanatory diagram for explaining a state of managing folders in a first information recording/reproducing device of FIG. 1;

FIG. 2B is an explanatory diagram for explaining a state of managing folders in the first information recording/reproducing device of FIG. 1;

FIG. 3A is an explanatory diagram for explaining a state of managing folders in a second information recording/reproducing device of FIG. 1;

FIG. 3B is an explanatory diagram for explaining a state of managing folders in the second information recording/reproducing device of FIG. 1;

FIG. 4 is a flowchart for explaining the synchronous folder processing operation in the first information recording/reproducing device of FIG. 1;

FIG. 5 is an explanatory diagram for explaining the contents in a synchronous folder obtained after the synchronous folder processing operation in the first information recording/reproducing device of FIG. 1;

FIG. 6 is another explanatory diagram for explaining the content in the synchronous folder obtained after the synchronous folder processing operation in the first information recording/reproducing device of FIG. 1;

FIG. 7A is an explanatory view showing a screen when a recording reservation is made in the first information recording/reproducing device of FIG. 1;

FIG. 7B is an explanatory view showing a screen when data from a memory is stored in the first information recording/reproducing device of FIG. 1;

FIG. 8 is an explanatory view showing a menu screen in the first information recording/reproducing device of FIG. 1;

FIG. 9 is an explanatory view showing a screen when a synchronous folder is newly prepared in the first information recording/reproducing device of FIG. 1;

FIG. 10 is an explanatory view showing a screen when the synchronous folder is processed in the first information recording/reproducing device of FIG. 1;

FIG. 11 is an explanatory view showing a screen when content to be stored in a synchronous folder is designated and the designation is cancelled in the first information recording/reproducing device of FIG. 1; and

FIG. 12 is an exemplary block diagram showing the configuration of another information recording/reproducing device to which the invention has been applied.

### DETAILED DESCRIPTION

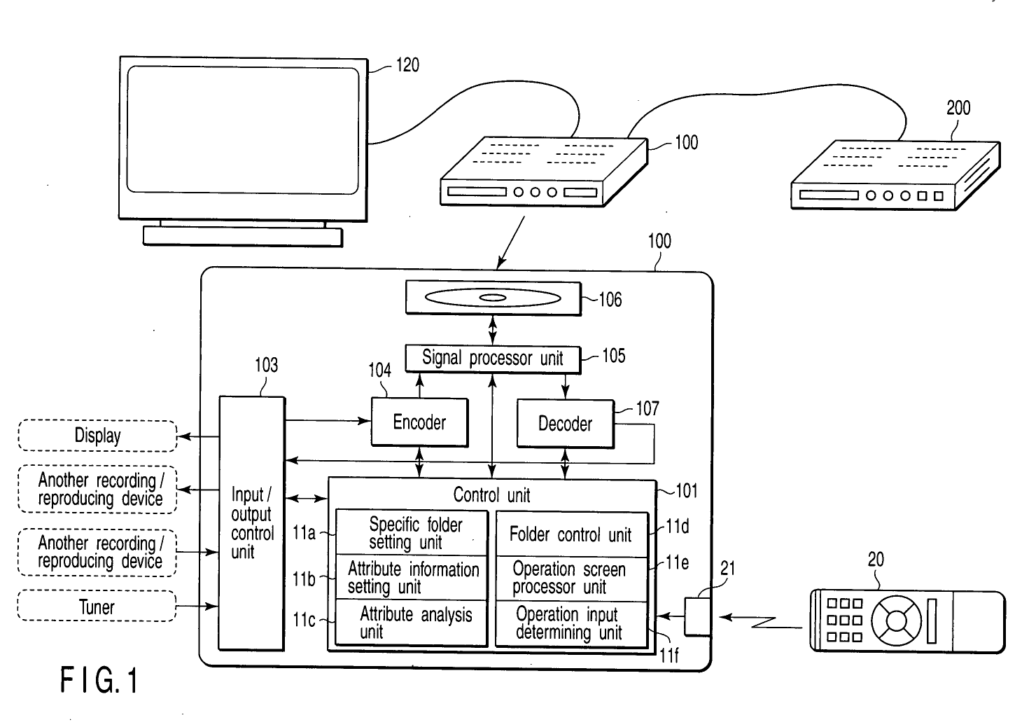

Various embodiments according to the invention will be described hereinafter with reference to the accompanying drawings. FIG. 1 shows the configuration of a flat-panel video display apparatus to which the present invention is applied.

FIG. 1 shows a condition in which a first information recording/reproducing device 100 and a second information recording/reproducing device 200 are connected via a network. Further, in the drawing, a display 120 is connected to the first information recording/reproducing device 100. The first information recording/reproducing device 100 is overall controlled by a control unit 101. An input/output control unit 103 is to obtain connections between external devices and the first information recording/reproducing device 100. The external devices includes the display 120, the aforementioned information recording/reproducing device 200, a tuner, and the like. Examples of the tuner include an analog tuner, a digital tuner for receiving digital broadcasting, and further a set-top box and a hub. Accordingly, the input/output control unit 103 also serves as a network connection unit. Because the first information recording/reproducing device 100 and the second information recording/reproducing device 200 have substantially the same configuration, the first information recording/reproducing device 100 will be described as representative of both.

Now, it is assumed that recording of a received program is carried out. A signal received with a tuner and demodulated is inputted into an encoder 104. The encoder 104 converts a digital video signal into a predetermined format, and supplies the converted signal to a signal processor unit 105. In the signal processor unit 105, an error-correcting code is added to an input signal, and the input signal is further modulated and is recorded in a recording medium 106 (for example, a hard disk in this embodiment). The data recorded in the recording medium 106 is read out and demodulated by the signal processor unit 105, and is subjected to error correction or the like. The data subjected to error-correction processing is decoded by a decoder 107 to be a baseband digital video signal, and is output to the input/output control unit 103.

When a digital video signal is displayed, the input/output control unit 103 converts a video signal into an analog signal, and supplies the converted signal to a display. Further, when a digital video signal is transmitted to another recording/reproducing device, the input/output control unit 103 converts a digital video signal into a format for transmission, and outputs the converted signal. In this case, it is also possible to transmit the signal, which is not in a state of baseband digital video signal, but in a state of file. Reference numeral 20 is a remote controller, and a manipulate signal outputted therefrom is taken into the control unit 101 via a receiving unit 21.

The control unit 101 overall controls the above-described operations. Moreover, the device has an information processor unit as follows. More specifically, the device has: a specific folder setting unit 11a which sets a specific folder in which content having predetermined attribute information associated therewith is collected and stored; an attribute information setting unit 11b which sets the attribute information to content to be stored in the specific folder; an attribute analysis unit 11c which analyzes the attribute information when content to be stored is taken in; and a folder control unit 11d which, when the content to be stored has predetermined attribute information as a result of analysis in the attribute analysis unit, distributes the content to be stored to the specific folder to store. Further, the device has an operation screen processor unit 11e by which an operation screen is displayed on a display at the time of executing movement or the like. Furthermore, the device has an operation input determining unit 11f for causing the device to execute processing corresponding to operating content in such a manner that content is determined by analyzing a manipulate signal input from the remote controller 20.

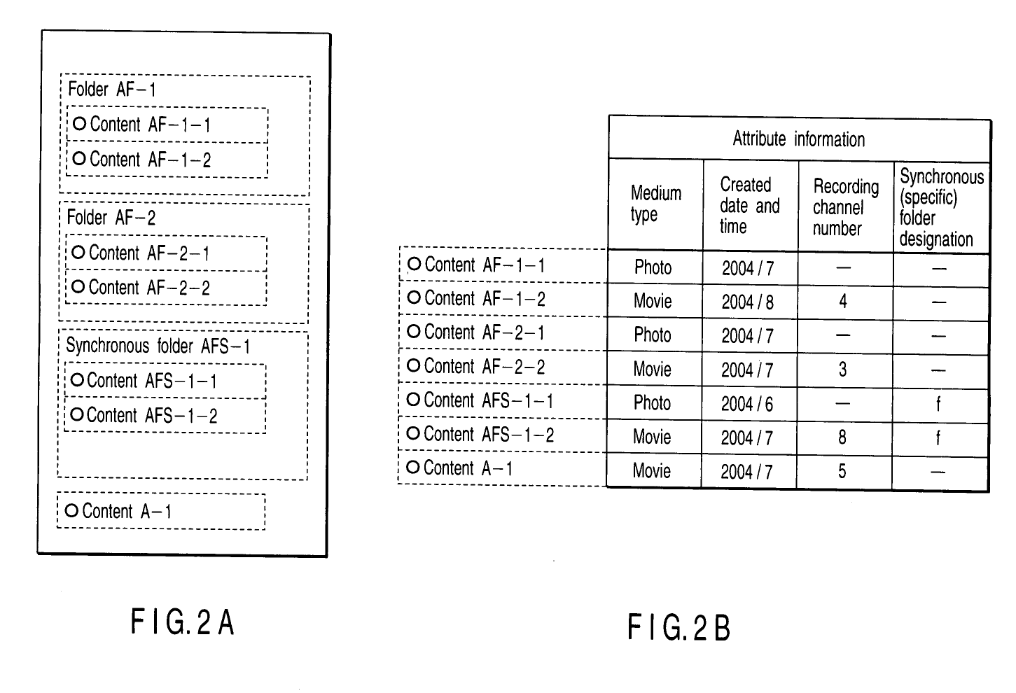

FIGS. 2A and 2B show examples of a state of managing folders in the first information recording/reproducing device 100 and of attribute information accompanied by the content in the folders. Here, for example, management due to a file system is carried out.

It is assumed that, as shown in FIG. 2A, folders AF-1 and AF-2, a synchronous (specific) folder AFS-1, and a content A-1 are managed in the first information recording/reproducing device 100. In this case, it is assumed that content AF-1-1 and AF-1-2 are stored in the folder AF-1, content AF-2-1 and AF-2-2 are stored in the folder AF-2, and content AFS-1-1 and AFS-1-2 are stored in the synchronous (specific) folder AFS-1.

To check the attribute information of the respective content, it is assumed that, as shown in FIG. 2B, as a media type, content AF-1-1 is Photo, content AF-1-2 is Movie, content AF-2-1 is Photo, content AF-2-2 is Movie, content AFS-1-1 is Photo, content AFS-1-2 is Movie, and content A-1 is Movie. Further, information on created date and time are added to the respective content. Moreover, in the respective content, channel numbers are added to Movies acquired from broadcast signals. There is no channel number with respect to Photos.

Here, specific folder designating information “f” are added to the content stored in the synchronous (specific) folder AFS-1. Note that this symbol of specific folder designating information is illustrative only, and may be an arbitrary agreed-upon symbol.

As attribute information, other various information may be added. For example, those may be information, such as identification data of genres and names of cast members, which can be acquired from program information, or may be information added by a user at the time of recording. Also, copy restriction information (information such as copy inhibit, one-time copiable, and copy free) are added.

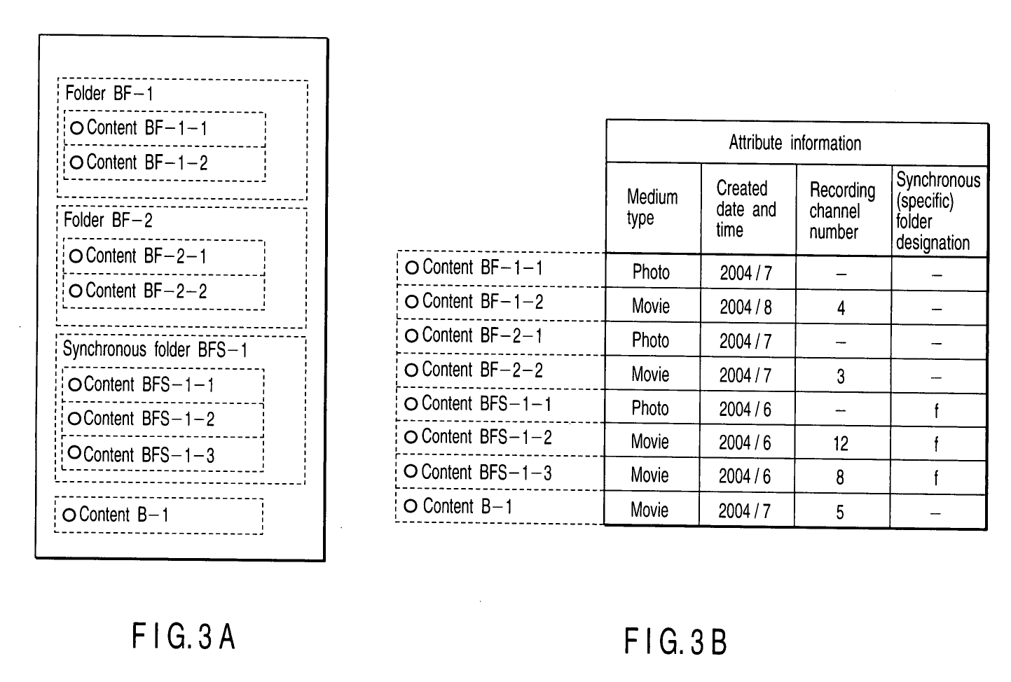

FIGS. 3A and 3B show examples of a state of managing folders in the first information recording/reproducing device 200 and of attribute information accompanied by the content in the folders.

It is assumed that, as shown in FIG. 3A, folders BF-1 and BF-2, synchronous (specific) folder BFS-1, and content B-1 are managed in the second information recording/reproducing device 200. In this case, it is assumed that content BF-1-1 and BF-1-2 are stored in folder BF-1, content BF-2-1 and BF-2-2 are stored in folder BF-2, and content BFS-1-1, BFS-1-2, and BFS-1-3 are stored in synchronous (specific) folder BFS-1.

To check the attribute information of the respective content, it is assumed that, as shown in FIG. 3B, as a media type, content BF-1-1 is Photo, content BF-1-2 is Movie, content BF-2-1 is Photo, content BF-2-2 is Movie, content BFS-1-1 is Photo, content BFS-1-2 is Movie, content B-1-3 is Movie, and content B-1 is Movie. Further, information on created date and time are added to the respective content. Moreover, in the respective content, channel numbers are added to Movies acquired from broadcast signals. There is no channel number with respect to Photos.

Here, specific folder designating information “f” are added to the content stored in the synchronous (specific) folder BFS-1. Note that, in this case as well, this symbol for specific folder designating information is illustrative only, and may be an arbitrary agreed-upon symbol. As attribute information, other various information may be added. For example, those may be information, such as identification data of genres and names of cast members, which can be acquired from program information, and may be information added by a user at the time of recording. Further, copy restriction information (information such as copy inhibit, one-time copiable, and copy free) are added.

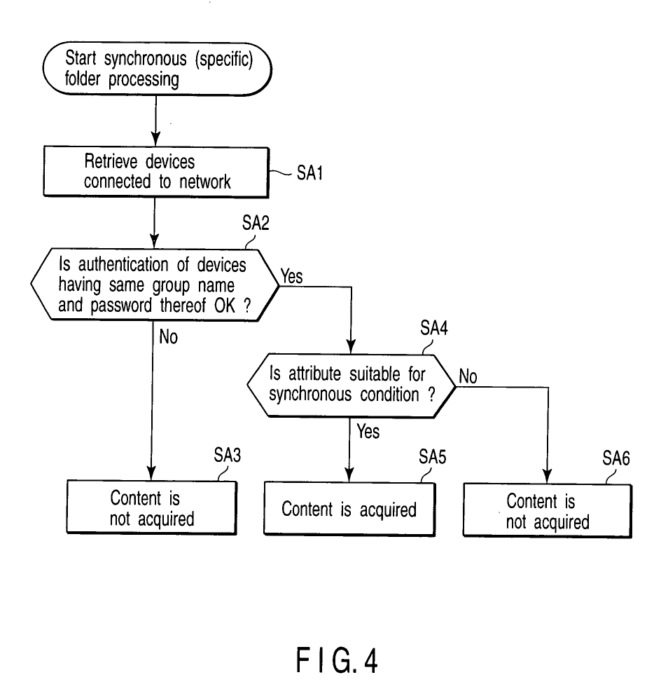

In FIG. 4, steps of operations at the time of realizing copy processing are shown on the basis of information on the synchronous folder.

Now, it is assumed synchronous processing is started in the first information recording/reproducing device 100. Then, the first information recording/reproducing device 100 retrieves a device connected to a network (step SA1), and detects the second information recording/reproducing device 200. The first information recording/reproducing device 100 then determines whether or not the second information recording/reproducing device 200 is a device having a same group name, and makes authentication of a password thereof (step SA2). When the group name is different or the authentication ends in failure, an operation of acquiring content is not carried out (step SA3). When, in step A2, it is proved to be an device having a same group name, and authentication of a password thereof is approved, attribute information on the content stored in the synchronous folder is acquired. It is determined whether or not synchronous condition information for determining whether or not the first information recording/reproducing device 100 acquires content from the second information recording/reproducing device 200 is included in the attribute information (step SA4). When the synchronous condition information is included in the attribute information, a corresponding content is acquired (step SA5). Then, the acquired content is stored along the attribute information in the synchronous (specific) folder AFS-1 in the first information recording/reproducing device 100. As will be described later, the above-described synchronous condition information can be designated by a user, for example, before synchronous processing is started. When, in step SA4, the synchronous condition information is not included in the attribute information, the corresponding content is not acquired (step SA6).

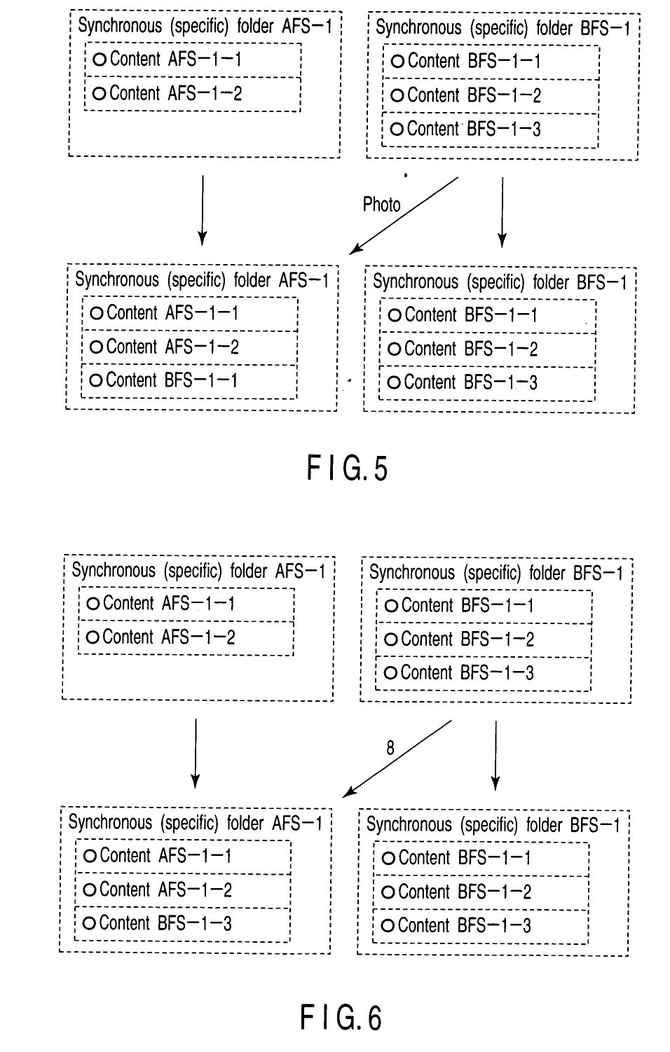

FIG. 5 is an example in the case where Photo is designated as the synchronous condition information in the above-described operation. The upper stage in FIG. 5 shows synchronous folders AFS-1 and BFS-1 before synchronous processing, and the lower stage in FIG. 5 shows synchronous folders AFS-1 and BFS-1 after synchronous processing. Content BFS-1-1 in synchronous folder BFS-1 is copied in synchronous folder AFS-1 after synchronous processing.

FIG. 6 is an example in the case where a channel 8 is designated as the synchronous condition information in the above-described operation. The upper stage in FIG. 6 shows synchronous folders AFS-1 and BFS-1 before synchronous processing, and the lower stage in FIG. 6 shows synchronous folders AFS-1 and BFS-1 after synchronous processing. Content BFS-1-3 in synchronous folder BFS-1 is copied in synchronous folder AFS-1 after synchronous processing.

The examples of FIGS. 5 and 6 each show the case where the content in synchronous folder BFS-1 is copied into synchronous folder AFS-1. If attribute information of copy inhibit and permission of movement are accompanied by the content, however, the moved content is eliminated from the sender folder.

Next, explanation will be given for how to determine contents to be stored in a synchronous (specific) folder.

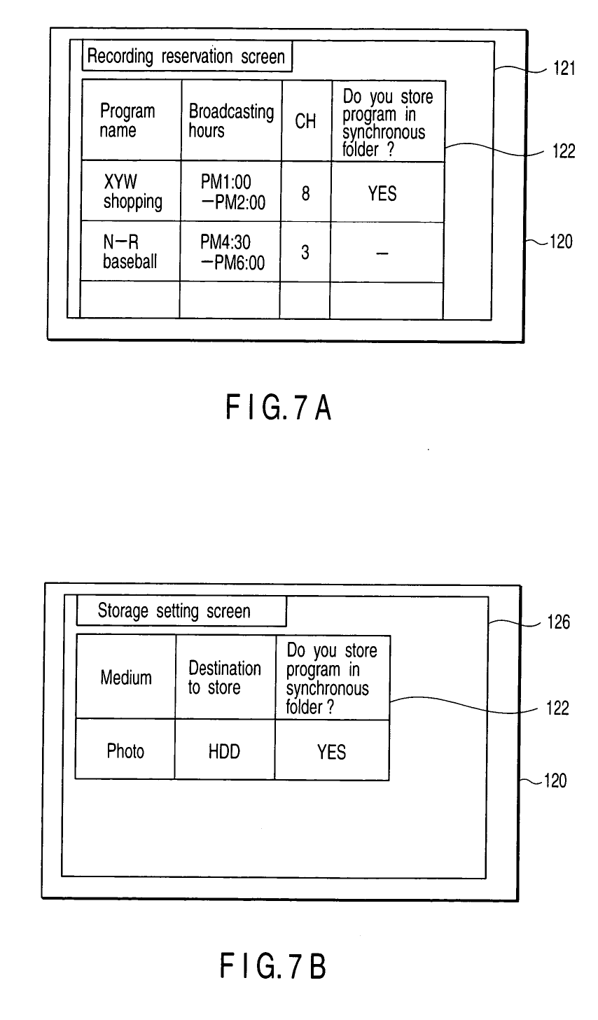

For example, when a recording reservation is made, a recording reservation screen appears on the display 120, as shown in FIG. 7A. Here, for example, electronic program information is used to display a table 121 in which program names, broadcasting hours, channel numbers, and the like are indicated. Moreover, the device is provided with designation columns 122 for deciding whether or not it is content to be stored in a synchronous (specific) folder as attribute of a program of which a recording reservation is made.

For example, when photo data or the like is fetched from external memory and is recorded in an information recording medium, a storage setting screen 126 is displayed, as shown in FIG. 7B. Then, there are provided the designation column 122 for deciding whether or not it is a content to be stored in a synchronous (specific) folder as attribute of media information to be stored.

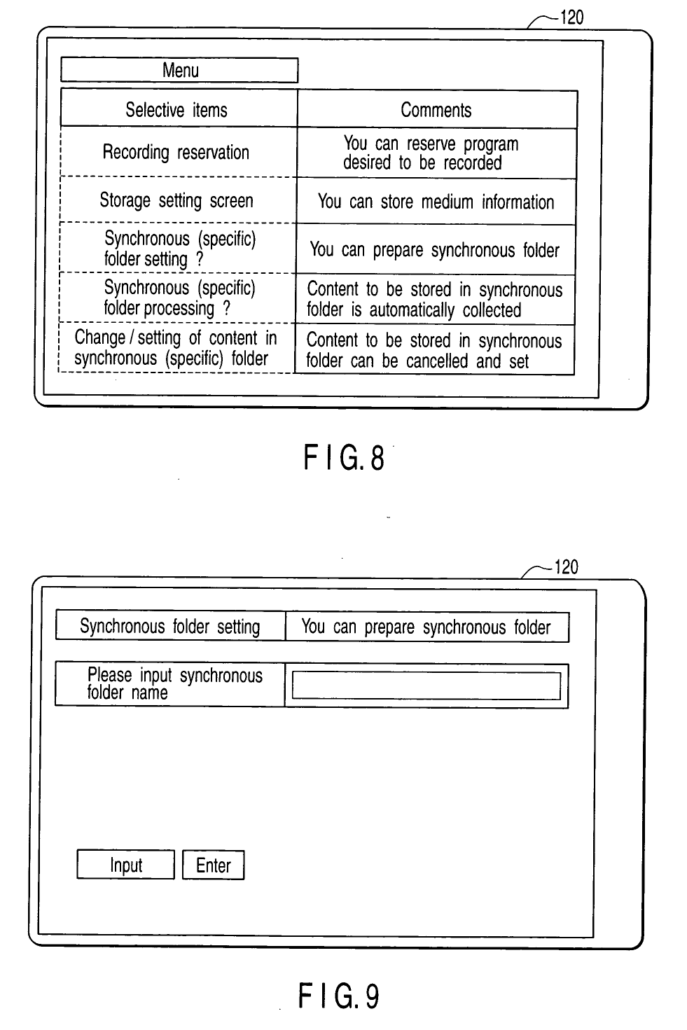

When a menu screen is designated by the remote controller 20, the menu screen appears, for example, as shown in FIG. 8. In this case, a menu particularly relating to the invention is shown. Other items are also displayed by scrolling the screen.

On the menu screen, selective items appear on the left side, and functions obtained when the respective items are selected are described on the right side. Now, when the cursor is pointed to the item “recording reservation” by operating the remote controller, and the Enter button is pressed, a screen as shown in FIG. 7A above can be obtained. Further, when the cursor is pointed to the item “storage setting screen”, and the Enter button is pressed, a screen as shown in FIG. 7B above can be obtained.

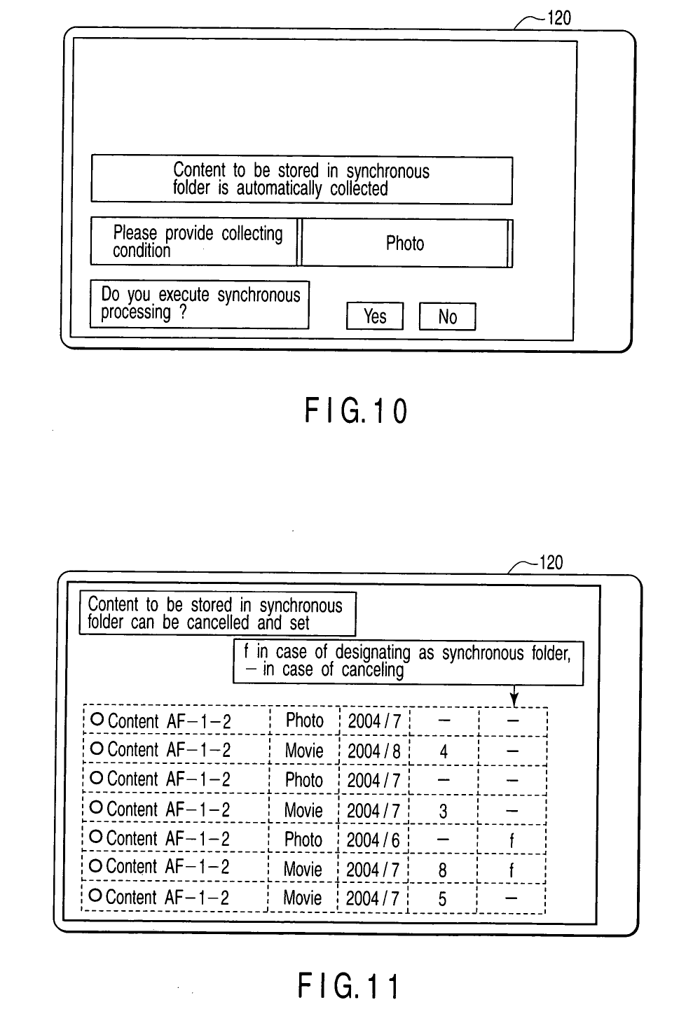

Moreover, the cursor is pointed to the item “synchronous (specific) folder setting?”, and the Enter button is pressed on the menu screen, so that a screen as shown in FIG. 9 can be obtained. On this screen, a synchronous folder name can be input to be decided. The synchronous folder name in the case of the device 100 is AFS-1. The synchronous folder name in the case of the device 200 is BFS-1. When the cursor is pointed to the item “synchronous (specific) folder processing?”, and the Enter button is pressed on the menu screen, a screen as shown in FIG. 10 can be obtained. On this screen, the message “Do you execute synchronous processing?” appears. Here, if the cursor is pointed to the item “Yes”, and the Enter button is pressed, collection of content satisfying the conditions is automatically started. Because an item for inputting condition also appears, a condition can be input in the blank next to the item. The results of the collection processing are as described in FIGS. 5 and 6.

In addition, when the cursor is pointed to the item “change/setting of synchronous (specific) folder contents”, and the Enter button is pressed on the menu screen of FIG. 8, a screen as shown in FIG. 11 can be obtained. Here, a table as shown in FIG. 2B is displayed on the screen. Then, a flag indicative of whether or not it is designated as content to be stored in the synchronous folder can be input to the column of “synchronous folder designation”. When it is designated as content to be stored in the synchronous folder, “f” is input, and otherwise, “-” is input.

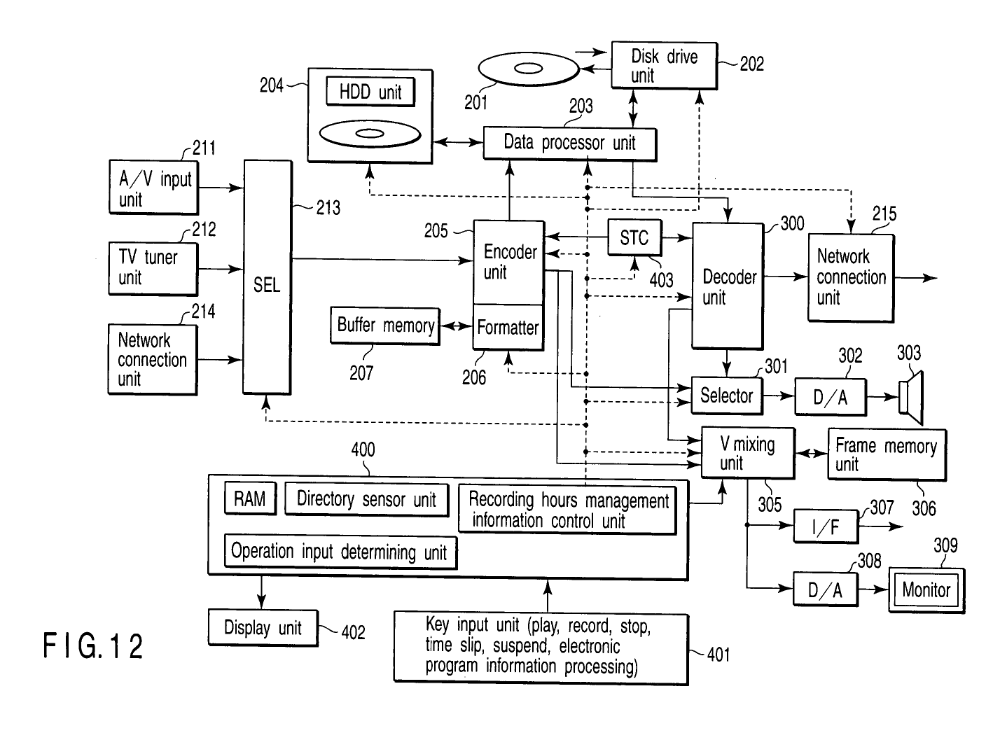

FIG. 12 shows another example of an information recording/reproducing device. In the information recording/reproducing device, a DVD and a hard disk can be utilized as information recording media.

A signal input to the encoder unit 205 is a signal selected from among signals from an A/V input unit 211, a TV tuner unit 212, or a network connection unit 214 by a selector 213.

An optical disk 201 is an information recording medium in which a video file can be constituted. A disk drive unit 202 drives the optical disk 201 to rotate, and executes read/write of information. Reference numeral 204 is a hard disk drive (HDD) unit for driving a hard disk.

A data processor unit 203 can supply recording data to the disk drive unit 202 and the hard disk drive unit 204, and can receive reproduced signals. The disk drive unit 202 has a rotation control system, a laser drive system, an optical system, and the like for the optical disk 201.

The data processor unit 203 is to handle data in recording or reproducing units, and includes a buffer circuit, a modulation/demodulator circuit, an error correction unit, and the like.

The recording/reproducing device has the encoder unit 205 configuring the recording side, a decoder unit 300 configuring the reproducing side, and a microcomputer block 400 for overall controlling the operations of the device main body, so as to be main components. The encoder unit 205 has video and audio analog-to-digital converters which digitize input analog video signals and analog audio signals, a video encoder, and an audio encoder. Moreover, the encoder unit 205 includes a sub-picture encoder which compresses subtitles of a film or the like.

An output of the encoder unit 205 is converted into a predetermined DVD (DVD-R, DVD-RW, DVD-RAM, or the like) format by a formatter 206 including a buffer memory 207, and is supplied to the above data processor unit 203. To the encoder unit 205, an external analog video signal and an external analog audio signal are input from the A/V input unit 211, or an analog video signal and an analog audio signal are input from the TV tuner unit 212. Note that, when a digital video signal and a digital audio signal which have been compressed are directly input, the encoder unit 205 can also supply the compressed digital video signal and digital audio signal directly to the formatter 206. In addition, the encoder unit 205 can directly supply a digital video signal and a digital audio signal which have been digitized, directly to a video mixing unit 305 and an audio selector 301, respectively.

In the video encoder included in the encoder unit 205, a digital video signal is converted into a digital video signal compressed at a variable bit rate based on the MPEG 2 or MPEG 1 standard. An audio signal is converted into a digital audio signal compressed at a constant bit rate based on the MPEG or AC-3 standard, or into a linear PCM digital audio signal.

When sub-picture signals are input from the A/V input unit 211 (for example, signals from a DVD video player with an independent output terminal for sub-picture signals, and the like), or when DVD video signals having such a data structure are broadcast and received by the TV tuner unit 212, sub-picture signals in the DVD video signals are encoded (run-length limited encoded) by the sub-picture encoder to be a bit map of sub-picture.

The digital video signals, digital audio signals, and sub-picture data which have been encoded are packed into a video pack, an audio pack, and a sub-picture pack by the formatter 206, and those are further collected and converted into a format stipulated in accordance with a DVD-recording standard (for example, a standard for recording on DVD-RAM, DVD-R, DVD-RW, or the like).

Here, the device can supply the information formatted by the formatter 206 (packs of video, audio, sub-picture data, and the like) and prepared management information to the hard disk drive unit 204 or the data disk drive unit 202 via the data processor unit 203 to record in a hard disk or the optical disk 201. The information recorded in a hard disk or the optical disk 201 may be recorded in the optical disk 201 or a hard disk via the data processor unit 203 and the data disk drive unit 202.

Besides, it is possible to carry out editing processing such as partially eliminating video objects of a plurality of programs recorded in a hard disk or the optical disk 201, connecting objects of different programs, or the like. This is because a data unit handled by a DVD format is defined and editing is made easier by processing signals in the data units.

The microcomputer block 400 includes a microprocessor unit (MPU) or a central processor unit (CPU), a ROM having a control program and the like written therein, and a RAM for providing a work area required for executing a program.

The MPU of the microcomputer block 400 uses the RAM as a work area in accordance with the control program stored in the ROM, and executes defect place detection, unrecorded region detection, recorded information recording position setting, UDF recording, AV address setting, and the like.

The microcomputer block 400 also has an information processor unit required for controlling the entire system, and includes a work RAM, a directory detecting unit, a VMG (entire video management information) information preparing unit, a copy related information sensor unit, a copying and scrambling information processor unit (PDI processor unit), a packet header processor unit, a sequence header processor unit, and an aspect ratio information processor unit.

Among results of executions by the MPU, content to be notified to a user is displayed on a display unit 402 of an image data recording/reproducing device, or are displayed in OSD (on-screen display) on a monitor display. Further, the microcomputer block 400 has a key input unit 401 which provides a manipulation signal for operating the device. Timings at which the microcomputer block 400 controls the disk drive unit 202, the hard disk drive unit 204, the data processor unit 203, the encoder unit 205 and/or the decoder unit 300 can be achieved on the basis of time data from a system time clock (STC) 403.

Operations for recording and reproduction are usually executed in synchronization with a time clock from the STC 403. However, the other processings may be executed at timings independently of the STC 403.

The decoder unit 300 has a separator which separates and takes out respective packs from signals in a DVD format having pack structures, a memory used at the time of executing pack separation and other signal processing, a V decoder which decodes main-picture data (contents in a video pack) separated by the separator, an SP decoder which decodes sub-picture data (contents in a sub-picture pack) separated by the separator, and an A decoder which decodes audio data (contents in an audio pack) separated by the separator. The decoder unit 300 also includes a video processor in which a decoded sub-picture is appropriately composed onto decoded main-picture, and the main-image is outputted so as to be superimposed with a menu, highlight buttons, subtitles, or another sub-image.

An output video signal from the decoder unit 300 is inputted to the video mixing unit 305. The video mixing unit 305 composes text data. Further, the video mixing unit 305 is connected with a line for directly taking in signals from the TV tuner 212 and the A/V input unit 211. A frame memory 306 used as a buffer is connected to the video mixing unit 305. When an output from the video mixing unit 305 is an analog output, the output is output to the exterior via an interface (I/F) 307, and when an output from the video mixing unit 305 is a digital output, the output is output to the exterior via a digital-to-analog converter 308. Also, an output from the decoder unit 300 can be outputted onto a network via a network connection unit 215. In the network connection units 214 and 215, authentication processings among equipments are carried out so as to be combined with the control unit.

The video mixing unit 305 can output an image signal for preparing a guide screen as a GUI. The image signal is controlled by a guide screen processing control unit 40d in the microcomputer block 400.

Moreover, an operation input determining unit and the like are provided, and the control unit 400 can overall control the entire device.

All the components are not illustrated in the microcomputer block 400. However, the microcomputer block 400 has, as shown in FIG. 1, a specific folder setting unit 11a which sets a specific folder in which content having predetermined attribute information associated therewith is collected and stored, an attribute information setting unit 11b which sets the attribute information to content stored in the specific folder, an attribute analysis unit 11c which analyzes the attribute information when content to be stored is taken in, and a folder control unit 11d which, when the content to be stored has predetermined attribute information as a result of analysis in the attribute analysis unit, distributes the content to be stored to the specific folder to be stored. The microcomputer block 400 also has the operation screen processor unit 11e by which an operation screen is displayed on a display at the time of executing movement or the like. Furthermore, the microcomputer block 400 includes the operation input determining unit 11f for causing the device to execute processing corresponding to operating content in such a manner that content is determined by analyzing a manipulate signal input from the remote controller.

A composite signal is recorded in a predetermined format (for example, a DVD format) on a recording medium which is designated in a recording mode, for example, a hard disk. Of course, management information for reproducing the composite signal is also prepared and recorded on the recording medium at this time. In addition, a breakpoint from a breakpoint setting processor unit 11f (chapter cutoff point) is included as, for example, entry point information in the management information.

An output audio signal from the decoder unit 300 is converted to analog by a digital-to-analog converter 302 and is output to the exterior via the selector 301. The selector 301 is controlled by a select signal from the microcomputer block 400. Consequently, the selector 301 can also directly select a signal having passed through the encoder unit 205 at the time of directly monitoring digital signals from the TV tuner 212 and the A/V input unit 211.

Note that, in the formatter of the encoder unit 205, respective segment information is prepared during recording, and this is periodically transmitted to the MPU of the microcomputer block 400 (information at the time of interrupting the head of GOP). The segment information include the number of VOBU (video object unit) packs, an end address of I pictures from the head of VOBU, and a reproduction time of VOBU.

At the same time, information from the aspect information processor unit is transmitted to the MPU at the time of starting recording, and the MPU prepares stream information (STI). Here, resolution data, aspect data, and the like are stored as the STI, and at the time of reproduction, initial settings are carried out on the basis of the information in the respective decoders.

In this device, a video file is stored up to one file per one disk. Further, in order to continue reproduction seamlessly during an access (seeking) of data, an information unit (size) which continues minimally is defined. This unit is called a CDA (contiguous data area). A CDA size is a multiple number of an ECC (error-correction code) block (16 sectors), and recording is carried out in the CDA units in a file system.

The data processor unit 203 receives data in VOBU units from the formatter of the encoder unit 205, and supplies data in CDA units to the disk drive unit 202 or the hard disk drive unit 204. The MPU of the microcomputer block 400 prepares management information necessary for reproducing recorded data, and transmits the prepared management information to the data processor unit 203 when a command to end data recording is recognized. Consequently, the management information is recorded on the disk. Accordingly, when encoding is being carried out, the MPU of the microcomputer block 400 receives information in data units (segment information or the like) from the encoder unit 205. Further, the MPU of the microcomputer block 400 recognizes the management information (file system) read out of the optical disk and the hard disk at the time of starting recording, and recognizes unrecorded areas on the respective disks, and recorded areas on the data are set onto the disk via the data processor unit 103.

The embodiment shown in FIG. 1 has explained copying or movement of signals between the two information recording/reproducing devices 100 and 200. However, in the device of the embodiment, information recording/reproducing devices may be further installed more, and content suitable for the conditions can be collected in a synchronous folder from among a plurality of information recording/reproducing devices.

When a plurality of devices of the invention are connected, it is assumed that desired attribute information (for example, a genre) for storing data in a synchronous folder is input as a condition. In this case, content suitable for the condition can be collected from devices in a same group into the synchronous folder. Further, when the third device designates, for example, news as a condition in the synchronous folder in which the content has been collected, content in a genre further refined can be collected. Moreover, when a recording date and time and the like are designated, more refined content can be collected.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information recording/reproducing device comprising: a connection unit which is connected to a network; an encoder which encodes an input signal from the connection unit in a predetermined format; a recording processor unit which records encoded data on an information recording medium; a reproducing processor unit which reproduces data recorded on the information recording medium; a decoder which decodes reproduced data, and a control unit which overall controls the device, the network-compliant information recording/reproducing device comprising:
a specific folder setting unit which sets a specific folder in which content having predetermined attribute information associated therewith is collected and stored;
an attribute information setting unit which sets the attribute information with respect to content stored in the specific folder;
an attribute analysis unit which analyzes the attribute information when content to be stored is taken in via the connection unit; and
a folder control unit which, when the content to be stored has predetermined attribute information suitable for a condition as a result of analysis in the attribute analysis unit, stores the content to be stored in the specific folder.

2. The network-compliant information recording/reproducing device according to claim 1, wherein, in the case where the content to be stored has attribute information different from the attribute information suitable for the condition when the attribute information is analyzed in the attribute analysis unit, the folder control unit cancels storage processing.

3. The network-compliant information recording/reproducing device according to claim 2, wherein, when password authentication processing is carried out and mutual authentication is obtained with an external information recording/reproducing device which is further connected via the connection unit, the attribute analysis unit carries out analysis of attribute information.

4. The network-compliant information recording/reproducing device according to claim 1, further comprising an operation screen processor unit, wherein the operation screen processor unit displays a recording reservation screen, and displays a designation input unit to designate whether or not a reserved program is stored in the specific folder on the recording reservation screen.

5. The network-compliant information recording/reproducing device according to claim 1, further comprising an operation screen processor unit, wherein the operation screen processor unit displays a storage setting screen to store information from an external memory, and displays a designation input unit to designate whether or not information to be stored is stored in the specific folder on the storage setting screen.

6. The network-compliant information recording/reproducing device according to claim 1, further comprising an operation screen processor unit, wherein the operation screen processor unit displays a specific folder setting screen to prepare the specific folder, and displays an input unit for a specific folder name on the specific folder setting screen.

7. The network-compliant information recording/reproducing device according to claim 1, further comprising an operation screen processor unit, wherein the operation screen processor unit displays a specific folder processing screen to execute the specific folder processing, and displays an input unit to input a condition of content to be collected in the specific folder on the specific folder processing screen.

8. The network-compliant information recording/reproducing device according to claim 1, further comprising an operation screen processor unit, wherein the operation screen processor unit displays a table of stored content so as to input flags denoting content to be collected and content not to be collected in the specific folder.

9. A method of controlling an information recording/reproducing device comprising: a connection unit which is connected to a network; an encoder which encodes an input signal from the connection unit in a predetermined format; a recording processor unit which records encoded data on an information recording medium; a reproducing processor unit which reproduces data recorded on the information recording medium; a decoder which decodes reproduced data; and a control unit which overall controls the device, the method comprising:
setting a specific folder in which content having predetermined attribute information associated therewith is collected and stored;
when content to be stored is taken in via the connection unit, analyzing attribute information accompanied by the content; and
when the content to be stored has predetermined attribute information suitable for a designated condition as a result of analysis of the attribute information, storing the content to be stored in the specific folder.

10. The method of controlling a network-compliant information recording/reproducing device, according to claim 9, further comprising:
when password authentication processing is carried out and mutual authentication is obtained with an external information recording/reproducing device which is further connected via the connection unit, performing analysis of the attribute information.
